(19) United States
(12) Patent Application Publication
(10) Pub. No.: US 2025/0245827 A1
(43) Pub. Date: Jul. 31, 2025

(54) PREDICTING TILE-LEVEL CLASS LABELS FOR HISTOPATHOLOGY IMAGES

(71) Applicant: Hoffmann-La Roche Inc., Little Falls, NJ (US)

(72) Inventors: Saadia Iftikhar, Basel (CH); Konstanty Korski, Basel (CH); Anil Yuce, Olten (CH); Samaneh Abbasi-Sureshjani, Basel (CH)

(21) Appl. No.: 19/183,107

(22) Filed: Apr. 18, 2025

Related U.S. Application Data
(63) Continuation of application No. PCT/US2023/077343, filed on Oct. 19, 2023.
(60) Provisional application No. 63/418,425, filed on Oct. 21, 2022.

(51) Int. Cl. G06T 7/00; G06N 3/0464; G06N 20/20; G06T 7/11

(52) U.S. Cl. CPC G06T 7/0012; G06N 3/0464; G06N 20/20; G06T 7/11; G06T 2207/10056; G06T 2207/20081; G06T 2207/30024

(57) ABSTRACT

A method implemented by one or more computer devices includes providing weakly-supervised neural networks for analysis of histopathology images. The method includes accessing a histopathology image including a slide-level class label. The method includes extracting a plurality of regions of pixels of the histopathology image at a plurality of magnifications. For each of the extracted plurality of regions of pixels, the method further includes inputting the region of pixels into a machine-learning model trained to generate a prediction of a class label for the region of pixels based on the region of pixels and the slide-level class label and outputting the prediction of the class label for the region of pixels. The method includes generating a prediction of one or more tile-level class labels for the histopathology image based on the predictions of class labels for each of the extracted plurality of regions of pixels.

### CROSS-REFERENCE TO RELATED APPLICATIONS

This application is a continuation of International Application No. PCT/US2023/077343, filed on Oct. 19, 2023, which claims priority to U.S. Provisional Patent Application No. 63/418,425, entitled “Predicting Tile-Level Class Labels for Histopathology Images” and filed on Oct. 21, 2022, the disclosure of each of which is incorporated herein by reference in its entirety.

### TECHNICAL FIELD

This application relates generally to histopathology images, and, more particularly, to techniques for predicting tile-level class labels for histopathology images.

### BACKGROUND

Histopathology images may generally enable the visualizing and analyzing of tissues or cells by histopathologists to ascertain, for example, whether variations occurring in tissues or cells are due to disease, toxicity, and/or natural processes. For example, histopathology images may include very large and high-resolution images, including up to 100K/100K pixels in some instances. Thus, enabling the efficient analysis of histopathology images may generally rely upon one or more image analysis tasks or machine-learning model-based tasks to convert raw image data into a qualitative ascertainment of the tissues or cells included within the histopathology images. Specifically, the one or more image analysis tasks or machine-learning model-based tasks may generally include image enhancement, image segmentation, image feature extraction, and, finally, image classification.

For example, some specific instances of the one or more image analysis tasks or machine-learning model-based tasks may include identifying certain regions of tissues or cells that appear normal, diseased, or correspond to one or more other similar categories of clinical interest. For example, by identifying the regions of tissues or cells that appear normal or diseased and quantifying the area, shape, or texture of these regions of tissues or cells, the one or more image analysis tasks or machine-learning model-based tasks may perform in minutes what would otherwise require hours of laborious efforts performed by a histopathologist. However, training machine-learning models, for example, to identify regions of tissues or cells that appear normal or diseased and quantifying the area, shape, or texture of these regions of tissues or cells may often require large data sets of histopathology images each including copious annotations. Specifically, in order to accumulate sufficient training data for accurately training the machine-learning models, a histopathologist or a number of other expert human annotators would have to manually annotate a large data set of histopathology images, which may each include thousands or millions of individual features of clinical interest. Indeed, such human annotations may be time-consuming, costly, and susceptible to immense human error.

### SUMMARY

Embodiments of the present disclosure are directed toward one or more computing devices, methods, and non-transitory computer-readable media that may be utilized to train one or more machine-learning models to generate a prediction of one or more tile-level class labels for a histopathology image based on a slide-level class label preassigned to the histopathology image. For example, in certain embodiments, one or more computing devices may access a histopathology image including a slide-level class label (e.g., a high-level or sparse image label or a hand-drawn bounding geometry covering too large of an area of disparate tissues, cells, or other features) preassigned to the histopathology image, for example, by a histopathologist or another expert human annotator. The one or more computing devices may then extract and downsample a number of image tiles of the histopathology image to a number of different magnifications (e.g., ranging from low-magnification, medium-magnification, and up to high-magnification).

In certain embodiments, the one or more computing devices may then input the number of image tiles at different magnifications into respective machine-learning models (e.g., an ensemble of machine-learning models) each trained to generate a prediction of a tile-level class label for the respective image tiles at different magnifications utilizing the image tile and the slide-level class label preassigned to the histopathology image. In certain embodiments, the predictions of a tile-level class label for the respective image tiles at different magnifications may be then averaged to generate one or more tile-level class label predictions for the histopathology image. In this way, the presently disclosed embodiments may provide predicted tile-level class labels for low-level features (e.g., a class label or bounding geometry identifying a specific region of cancer cells, a region of immune cells, one or more biomarkers corresponding to a specific region, or other region of features of clinical interest) within a histopathology image utilizing only the respective extracted and downsampled regions of pixels (e.g., one or more tiles of pixels) and a sparse slide-level class label preassigned to the histopathology image. Indeed, without the presently disclosed embodiments, such tile-level annotation tasks would otherwise require time-consuming, costly, and potentially erroneous human annotation. Additionally, by training the machine-learning models (e.g., an ensemble of machine-learning models) to predict tile-level class labels at different magnifications, once trained, the machine-learning models (e.g., an ensemble of machine-learning models) may be better suited for predicting tile-level class labels for features of histopathology images at different magnifications and/or resolutions (e.g., similar to the manner in which a histopathologist would analyze and classify features of histopathology images).

In certain embodiments, one or more computing devices may access a histopathology image, in which the histopathology image comprises a slide-level class label. For example, in some embodiments, the histopathology image may include at least one of a histological stain image, a fluorescence in situ hybridization (FISH) image, an immunofluorescence (IF) image, or a hematoxylin and eosin (H&E) image. In certain embodiments, the one or more computing devices may then extract, based on the histopathology image, a plurality of regions of pixels of the histopathology image at a plurality of magnifications. For example, in some embodiments, each one of the plurality of magnifications is different from each other one of the plurality of magnifications. In certain embodiments, extracting the plurality of regions of pixels of the histopathology image at the plurality of magnifications may include downsampling the plurality of regions of pixels to the plurality of magnifications.

In certain embodiments, for each of the extracted plurality of regions of pixels, the one or more computing devices may input the region of pixels into a machine-learning model trained to generate a prediction of a class label for the region of pixels based on the region of pixels and the slide-level class label, and to output, by the machine-learning model, the prediction of the class label for the region of pixels. For example, in one embodiment, the machine-learning model may include an artificial neural network (ANN), a convolutional neural network (CNN), or a deep neural network (DNN). In another embodiment, the machine-learning model may include one of an ensemble of convolutional neural networks (CNNs). In certain embodiments, the one or more computing devices may generate a prediction of one or more tile-level class labels for the histopathology image based on the predictions of class labels for each of the extracted plurality of regions of pixels. For example, in some embodiments, the prediction of the one or more tile-level class labels may include an identification of one or more biomarkers associated with tissues or cells included within the histopathology image.

In certain embodiments, prior to generating the prediction of the one or more tile-level class labels, the one or more computing devices may normalize the predictions of class labels for each of the extracted plurality of regions of pixels. For example, in some embodiments, normalizing the predictions of class labels for each of the extracted plurality of regions of pixels may include normalizing the predictions of class labels for each of the extracted plurality of regions of pixels to a scaling of the region of pixels at a maximum magnification. In certain embodiments, the one or more computing devices may generate the prediction of the one or more tile-level class labels by computing an average of the predictions of class labels for each of the extracted plurality of regions of pixels. In certain embodiments, the one or more computing devices training the one or more machine-learning models to generate the prediction of one or more tile-level class labels for the histopathology image may include training the one or more machine-learning models in accordance with a weakly-supervised learning process.

For example, in some embodiments, subsequent to training the one or more machine-learning models to generate a prediction of one or more tile-level class labels for a whole-slide histopathology image, the one or more computing devices may then access a second histopathology image, input the second histopathology image into the trained one or more machine-learning models to generate a prediction of one or more tile-level class labels for the second histopathology image, and output, by the one or more machine-learning models, the prediction of the one or more tile-level class labels for the second histopathology image. In certain embodiments, the prediction of the one or more tile-level class labels for the second histopathology image may include an identification of one or more biomarkers associated with tissues or cells included within the second histopathology image. In certain embodiments, the one or more computing devices may generate a report based on the prediction of the one or more tile-level class labels for the histopathology image. In one embodiment, the one or more computing devices may cause a human machine interface (HMI) associated with a pathologist or a clinician to display the report.

### BRIEF DESCRIPTION OF THE DRAWINGS

One or more drawings included herein are in color in accordance with 37 CFR § 1.84. The color drawings are necessary to illustrate the invention. More specifically, FIGS. 3, 6, 7A, 7B, and 8 are one or more high-resolution histopathology images of tissues or cells, all of which color plays a predominant role in enabling one skilled in the art to understand the invention and such color drawings are the only practical medium for disclosing the subject matter to be patented.

FIG. 1 illustrates an exemplary network of interacting computer systems.

FIG. 2 illustrates a system workflow diagram for training one or more machine-learning models to generate a prediction of one or more tile-level class labels for a histopathology image based on a slide-level class label preassigned to the histopathology image.

FIG. 3 illustrates an illustrative workflow diagram for training one or more machine-learning models to generate a prediction of one or more tile-level class labels for a histopathology image based on a slide-level class label preassigned to the histopathology image.

FIG. 4 illustrates a flow diagram of a method for training one or more machine-learning models to generate a prediction of one or more tile-level class labels for a histopathology image based on a slide-level class label preassigned to the histopathology image.

FIG. 5 illustrates a flow diagram of a method for utilizing one or more machine-learning models to generate a prediction of one or more tile-level class labels for a histopathology image based on a slide-level class label preassigned to the histopathology image.

FIG. 6 illustrates a running example of utilizing one or more machine-learning models to generate a prediction of one or more tile-level class labels for a histopathology image based on a slide-level class label preassigned to the histopathology image.

FIGS. 7A and 7B illustrate one or more graphical or implementation example of predictions of tile-level class labels for a histopathology image at different magnifications.

FIG. 8 illustrates an example machine-learning model evaluation diagram.

FIG. 9 illustrates a diagram of an example artificial intelligence (AI) architecture included as part of the network of interacting computer systems.

### DESCRIPTION OF EXAMPLE EMBODIMENTS

Embodiments of the present disclosure are directed toward one or more computing devices, methods, and non-transitory computer-readable media that may be utilized to train one or more machine-learning models to generate a prediction of one or more tile-level class labels for a histopathology image based on a slide-level class label preassigned to the histopathology image. For example, in certain embodiments, one or more computing devices may access a histopathology image including a slide-level class label (e.g., a high-level or sparse image label or a hand-drawn bounding geometry covering too large of an area of disparate tissues, cells, or other features) preassigned to the histopathology image, for example, by a histopathologist or another expert human annotator. The one or more computing devices may then extract and downsample a number of image tiles of the histopathology image to a number of different magnifications (e.g., ranging from low-magnification, medium-magnification, and up to high-magnification).

In certain embodiments, the one or more computing devices may then input the number of image tiles at different magnifications into respective machine-learning models (e.g., an ensemble of machine-learning models) each trained to generate a prediction of a tile-level class label for the image tiles at different magnifications utilizing the image tile and the slide-level class label preassigned to the histopathology image. In certain embodiments, the predictions of a tile-level class label for the respective image tiles at different magnifications may be then averaged to generate one or more tile-level class label predictions for the histopathology image.

In this way, the presently disclosed embodiments may provide predicted tile-level class labels for low-level features (e.g., a class label or bounding geometry identifying a specific region of cancer cells, a region of immune cells, one or more biomarkers corresponding to a specific region, or other region of features of clinical interest) within a histopathology image utilizing only the respective extracted and downsampled regions of pixels (e.g., one or more tiles of pixels) and a sparse slide-level class label preassigned to the histopathology image. Indeed, without the presently disclosed embodiments, such tile-level annotation tasks would otherwise require time-consuming, costly, and potentially erroneous human annotation. Additionally, by training the machine-learning models (e.g., an ensemble of machine-learning models) to predict tile-level class labels at different magnifications, once trained, the machine-learning models (e.g., an ensemble of machine-learning models) may be better suited for predicting tile-level class labels for features of histopathology images at different magnifications and/or resolutions (e.g., similar to the manner in which a histopathologist would analyze and classify features of histopathology images).

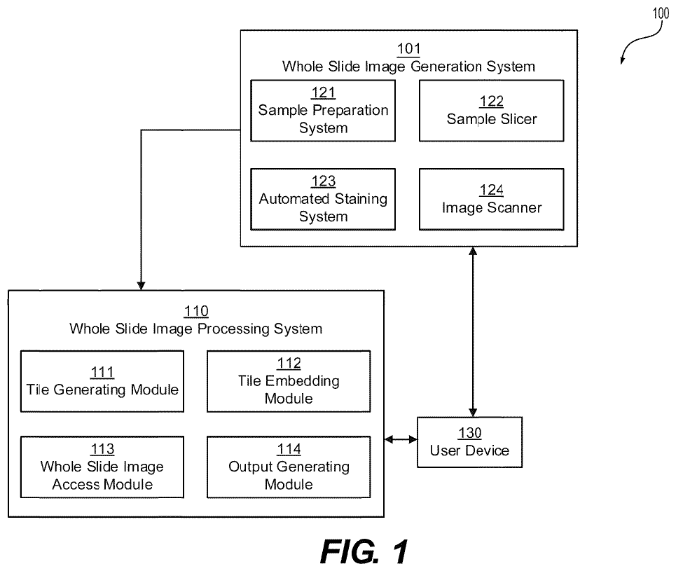

FIG. 1 illustrates a network 100 of interacting computer systems, one or more of which may be utilized to train one or more machine-learning models to generate a prediction of one or more tile-level class labels for a histopathology image based on a slide-level class label preassigned to the histopathology image, in accordance with the presently disclosed embodiments. In certain embodiments, a whole slide image generation system 110 may generate one or more whole slide images (WSIs) or other related histopathology images corresponding to a particular sample, for example. In one embodiment, one or more images generated by the whole slide image generation system 110 may include a stained section of a biopsy sample. In another embodiment, one or more images generated by the whole slide image generation system 110 may include a slide image (e.g., a blood film) of a liquid sample. In accordance with the presently disclosed embodiments, one or more images generated by the whole slide image generation system 110 may include, for example, any of various histopathology images, such as a fluorescence in situ hybridization (FISH) image, an immunofluorescence (IF) image, a multiplex immunofluorescence (mxIF) image, a hematoxylin and eosin (H&E) image, an immunohistochemistry (IHC) image, a multiplex immunohistochemistry (mxIHC) image, an imaging mass cytometry (IMC) image, and so forth.

In certain embodiments, some types of samples (e.g., biopsies, solid samples and/or samples including tissue) may be processed by a sample preparation system 121 to fix and/or embed the sample. The sample preparation system 121 may facilitate infiltrating the sample with a fixating agent (e.g., liquid fixing agent, such as a formaldehyde solution) and/or embedding substance (e.g., a histological wax). For example, a sample fixation sub-system may fix a sample by exposing the sample to a fixating agent for at least a threshold amount of time (e.g., at least 3 hours, at least 6 hours, or at least 13 hours). A dehydration sub-system may dehydrate the sample (e.g., by exposing the fixed sample and/or a portion of the fixed sample to one or more ethanol solutions) and potentially clear the dehydrated sample using a clearing intermediate agent (e.g., that includes ethanol and a histological wax). A sample embedding sub-system may infiltrate the sample (e.g., one or more times for corresponding predefined time periods) with a heated (e.g., and thus liquid) histological wax. The histological wax may include a paraffin wax and potentially one or more resins (e.g., styrene or polyethylene). The sample and wax may then be cooled, and the wax-infiltrated sample may then be blocked out.

In certain embodiments, a sample slicer 122 may receive the fixed and embedded sample and may produce a set of sections. The sample slicer 122 may expose the fixed and embedded sample to cool or cold temperatures. The sample slicer 122 may then cut the chilled sample (or a trimmed version thereof) to produce a set of sections. Each section may have a thickness that is (for example) less than 100 μm, less than 50 μm, less than 10 μm or less than 5 um. Each section may have a thickness that is (for example) greater than 0.1 μm, greater than 1 um, greater than 2 μm or greater than 4 μm. The cutting of the chilled sample may be performed in a warm water bath (e.g., at a temperature of at least 30° C., at least 35° C. or at least 40° C.). In certain embodiments, an automated staining system 123 may facilitate staining one or more of the sample sections by exposing each section to one or more staining agents.

In certain embodiments, each of one or more stained sections may be presented to an image scanner 124, which may capture a digital image of the section. In certain embodiments, the image scanner 124 may include a microscope camera. The image scanner 124 may capture the digital image at multiple magnifications (e.g., utilizing a 2× objective, a 5× objective, a 10× objective, a 20× objective, a 40× objective, a 100× objective, a 200× objective, a 500× objective, and so forth). Manipulation of the image may be used to capture a selected portion of the sample at the desired range of magnifications. Image scanner 124 may further capture annotations and/or morphometrics identified by a human operator. In some embodiments, a section may be returned to automated staining system 123 after one or more images are captured, such that the section may be washed, exposed to one or more other stains, and imaged again.

In certain embodiments, a given sample may be associated with one or more users (e.g., one or more physicians, laboratory technicians and/or medical providers) during processing and imaging. An associated user may include, by way of example and not of limitation, a person who ordered a test or biopsy that produced a sample being imaged, a person with permission to receive results of a test or biopsy, or a person who conducted analysis of the test or biopsy sample, among others. For example, a user may correspond to a physician, a histopathologist, a clinician, or a subject. A user may use one or one user devices 130 to submit one or more requests (e.g., that identify a subject) that a sample be processed by the whole slide image generation system 110 and that a resulting image be processed by a whole slide image processing system 110. In certain embodiments, the whole slide image generation system 110 may transmit an image produced by the image scanner 124 back to user device 130. The user device 130 may then communicate with the whole slide image processing system 110 to initiate automated processing of the image. In some embodiments, the whole slide image generation system 110 may provide an image produced by image scanner 124 to the whole slide image processing system 110 directly, for example, at the direction of the user of a user device 130.

In certain embodiments, the whole slide image processing system 110 may process histopathology images to classify the histopathology images and generate annotations for the histopathology images and related output. For example, a tile generating module 111 may define a set of tiles (e.g., a region of pixels or subregion of pixels) for each histopathology image. To define the set of tiles, the tile generating module 111 may segment the histopathology image into the set of tiles. In certain embodiments, the tiles may be non-overlapping (e.g., each tile includes pixels of the image not included in any other tile) or overlapping (e.g., each tile includes some portion of pixels of the image that are included in at least one other tile). Features such as whether or not tiles overlap, in addition to the size of each tile and the stride of the window (e.g., the image distance or pixels between a tile and a subsequent tile) may increase or decrease the data set for analysis, with more tiles (e.g., through overlapping or smaller tiles) increasing the potential resolution of eventual output and visualizations.

In some embodiments, tile generating module 111 may define a set of tiles for an image, in which each tile is of a predefined size and/or an offset between tiles is predefined. Furthermore, the tile generating module 111 may create multiple sets of tiles of varying size, overlap, step size, and so forth for each image. In some embodiments, the histopathology image itself may contain tile overlap, which may result from the imaging technique. Even segmentation without tile overlap may be a preferable solution to balance tile processing requirements and avoid influencing the embedding generation and weighting value generation. A tile size or tile offset may be determined, for example, by calculating one or more performance metrics (e.g., precision, recall, accuracy, and/or error) for each size/offset and by selecting a tile size and/or offset associated with one or more performance metrics above a predetermined threshold and/or associated with one or more optimal (e.g., high precision, highest recall, highest accuracy, and/or lowest error) performance metric(s).

In certain embodiments, the tile generating module 111 may further define a tile size depending on the type of abnormality being detected. For example, the tile generating module 111 may be configured with awareness of the type(s) of tissue abnormalities that the whole slide image processing system 110 will be searching for and may customize the tile size according to the tissue abnormalities to optimize detection. For example, the image generating module 111 may determine that, when the tissue abnormalities include searching for inflammation or necrosis in lung tissue, the tile size should be reduced to increase the scanning rate, while when the tissue abnormalities include abnormalities with Kupffer cells in liver tissues, the tile size should be increased to increase the opportunities for the whole slide image processing system 110 to analyze the Kupffer cells holistically.

In certain embodiments, the tile generating module 111 may further define the set of tiles for each histopathology image along one or more color channels or color combinations. As an example, histopathology images received by the whole slide image processing system 110 may include large-format, multi-color channel images having pixel color values for each pixel of the image specified for one of several color channels. Example color specifications or color spaces that may be used include the RGB, CMYK, HSL, HSV, or HSB color specifications. The set of tiles may be defined based on segmenting the color channels and/or generating a brightness map or grayscale equivalent of each tile. For example, for each segment of an image, the tile generating module 111 may provide a red tile, blue tile, green tile, and/or brightness tile, or the equivalent for the color specification used.

In certain embodiments, a tile embedding module 112 may generate an embedding for each tile in a corresponding feature embedding space. The embedding may be represented by the whole slide image processing system 110 as a feature vector for the tile. The tile embedding module 112 may utilize a neural network (e.g., a convolutional neural network (CNN)) or other similar image classification neural network) to generate a feature vector that represents each tile of the image. In certain embodiments, the tile embedding neural network may be based on, for example, a residual neural network (ResNet) image classification neural network trained on a dataset based on natural (e.g., non-medical) images, such as the ImageNet dataset. By using a non-specialized tile embedding network, the tile embedding module 112 may leverage known advances in efficiently processing images to generate embeddings. Furthermore, using a natural image dataset allows the embedding neural network to learn to discern differences between tile segments on a holistic level.

In other embodiments, the tile embedding network used by the tile embedding module 112 may be an embedding network customized to handle large numbers of tiles of large format images, such as histopathology images. Additionally, the tile embedding network used by the tile embedding module 112 may be trained using a custom dataset. For example, the tile embedding network may be trained using a variety of samples of WSIs or even trained using samples relevant to the subject matter for which the embedding network will be generating embeddings (e.g., scans of particular tissue types). Training the tile embedding network using specialized or customized sets of images may allow the tile embedding network to identify finer differences between tiles which may result in more detailed and accurate distances between tiles in the feature embedding space at the cost of additional time to acquire the images and the computational and economic cost of training multiple tile generating networks for use by the tile embedding module 112. The tile embedding module 112 may select from a library of tile embedding networks based on the type of images being processed by the whole slide image processing system 110.

In certain embodiments, a whole slide image access module 113 may manage requests to access WSIs from other modules of the whole slide image processing system 110 and the user device 130. For example, the whole slide image access module 113 may receive requests to identify a WSI based on a particular tile, an identifier for the tile, or an identifier for the whole slide image. The whole slide image access module 113 may perform tasks of confirming that the WSI is available to the requesting user, identifying the appropriate databases from which to retrieve the requested WSI, and retrieving any additional metadata that may be of interest to the requesting user or module.

In certain embodiments, an output generating module 114 of the whole slide image processing system 110 may generate output corresponding to result tile and result WSI datasets based on user request. As described herein, the output may include a variety of visualizations, interactive graphics, and reports based upon the type of request and the type of data that is available. In many embodiments, the output will be provided to the user device 130 for display, but in certain embodiments the output may be accessed directly from the whole slide image processing system 110. The output may be based on existence of and access to the appropriate data, so the output generating module 116 may be empowered to access metadata and anonymized patient information as needed. As with the other modules of the whole slide image processing system 110, the output generating module 114 may be updated and improved in a modular fashion, so that new output features may be provided to users without requiring significant downtime.

The general techniques described herein may be integrated into a variety of tools and use cases. For example, as described, a user (e.g., histopathologist or clinician) may access a user device 130 that is in communication with the whole slide image processing system 110 and provide a query image for analysis. The whole slide image processing system 110, or the connection to the whole slide image processing system 110 may be provided as a standalone software tool or package that searches for corresponding matches, identifies similar features, and generates appropriate output for the user upon request. As a standalone tool or plug-in that may be purchased or licensed on a streamlined basis, the tool may be used to augment the capabilities of a research or clinical lab. Additionally, the tool may be integrated into the services made available to the customer of whole slide image generation systems.

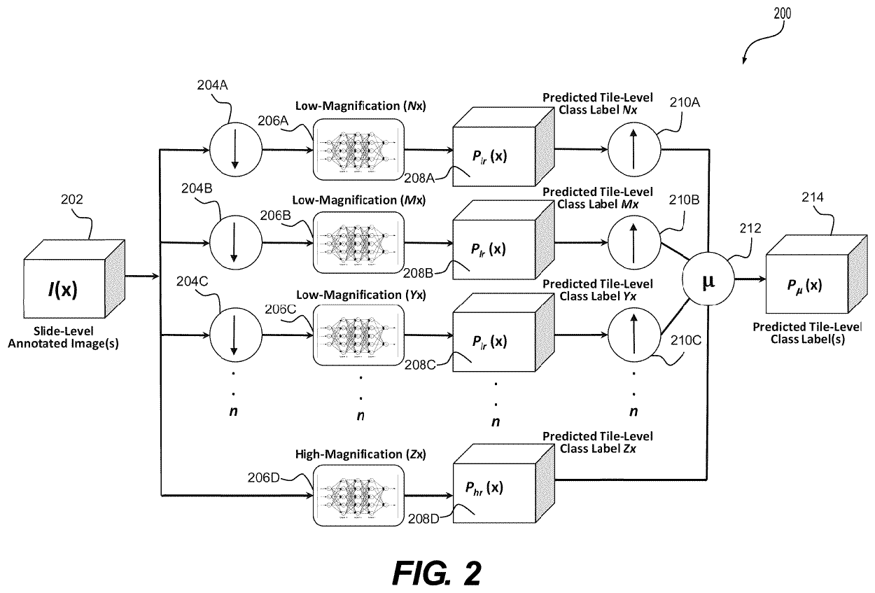

FIG. 2 illustrates a system workflow diagram 200 for training one or more machine-learning models to generate a prediction of one or more tile-level class labels for a histopathology image based on a slide-level class label preassigned to the histopathology image, in accordance with the presently disclosed embodiments. As depicted, in certain embodiments, a histopathology image 202 may be accessed. In one embodiment, the histopathology image 202 may have been generated and image processed in accordance with one or more techniques described above with respect to FIG. 1. In certain embodiments, the histopathology image 202 may include, for example, any of various WSIs, such as a fluorescence in situ hybridization (FISH) image, an immunofluorescence (IF) image, a multiplex immunofluorescence (mxIF) image, a hematoxylin and eosin (H&E) image, an immunohistochemistry (IHC) image, a multiplex immunohistochemistry (mxIHC) image, an imaging mass cytometry (IMC) image, and so forth.

In one embodiment, the histopathology image 202 may include one of a data set of histopathology images (e.g., hundreds or thousands of histopathology images), which may each include a very large and high-resolution image (e.g., 1.5K×2K pixels, 2K×4K pixels, 6K×8K pixels, 7.5K/10K pixels, 9K×12K pixels, 15K×20K pixels, 20K/24K pixels, 20K×30K pixels, 24K×30K pixels, 20K×40K pixels, 40K×60K pixels, 20K×80K pixels, 60K×80K pixels, 70K/100K pixels, 80K×100K pixels, 100K×100K pixels).

As further illustrated by FIG. 2, in some embodiments, the histopathology image 202 may be assigned a slide-level class label. For example, as previously noted, the histopathology image 202 may include a very large and high-resolution image depicting, for example, a large number of tissues or cells. In one embodiment, a histopathologist or other expert human annotator may assign a slide-level annotation (e.g., a high-level or sparse image label such as “carcinoma tumor” or a hand-drawn bounding geometry covering too large of an area of disparate tissues, cells, or other features) to the histopathology image 202. While it may be clinically beneficial for the histopathologist or other expert human annotator to further annotate the low-level features (e.g., assign a class label or bounding geometry identifying a specific region of cancer cells, a region of immune cells, one or more biomarkers corresponding to a specific region, or other region of features of clinical interest) within the histopathology image 202, such annotation tasks by way of human annotators may be time-consuming, costly, and susceptible to immense human error.

Thus, as will be further appreciated below, it may be useful to train one or more machine-learning models to generate a prediction of one or more tile-level annotations for the histopathology image 202 based on a slide-level annotation preassigned to the histopathology image 202. Indeed, as will be described in greater detail below, the one or more machine-learning models (e.g., machine-learning models 206A, 206B, 206C, and 206D) may be trained in accordance with a weakly-supervised learning process, in which the one or more machine-learning models (e.g., machine-learning models 206A, 206B, 206C, and 206D) may be trained to generate the prediction of one or more tile-level class labels for the histopathology image 202 based only on the slide-level class label in which there is no a-priori knowledge of which tiles of pixels of the histopathology image 202 are associated with the slide-level class label preassigned to the histopathology image 202.

In certain embodiments, as further depicted by FIG. 2, a number of regions of pixels (e.g., one or more tiles of pixels) of the histopathology image 202 may be extracted (e.g., sampled) and downsampled (e.g., by way of respective downsampling functions 202A, 202B, and 202C) to a number of magnifications (e.g., low-magnification “N×,” low-magnification “M×,” low-magnification “Y×,” and up to high-magnification “Z×,” where “N”; “M”; “Y” and “Z” each includes an integer greater than 1). In one embodiment, a first image tile (e.g., an image tile of 256×256 pixels) may be extracted and downsampled to 2× magnification, a second image tile (e.g., an image tile of 256×256 pixels) may be extracted and downsampled to 5× magnification, a third image tile (e.g., an image tile of 256×256 pixels) may be extracted and downsampled to 10× magnification, and a fourth image tile (e.g., an image tile of 256×256 pixels) may be extracted and downsampled to 20× magnification. However, it should be appreciated that the number of regions of pixels (e.g., one or more tiles of pixels) may be extracted and downsampled to any number of magnifications (e.g., 2× magnification, 5× magnification 10× magnification, 20× magnification, 50× magnification, 100× magnification, 200× magnification, 500× magnification, and so forth) in accordance with the presently disclosed embodiments.

In certain embodiments, as further depicted by FIG. 2, the number of regions of pixels (e.g., one or more tiles of pixels) may be then inputted into respective machine-learning models 206A, 206B, 206C, and 206D. For example, in some embodiments, the machine-learning models 206A, 206B, 206C, and 206D may each include a convolutional neural network (CNN) or a deep neural network (DNN). In one embodiment, the machine-learning models 206A, 206B, 206C, and 206D may include an ensemble of machine-learning models (e.g., ensemble of CNNs or other similar image classification neural networks trained in parallel or end-to-end), in which each of the machine-learning models 206A, 206B, 206C, and 206D may be based on a residual neural network (ResNet) image classification neural network or a deep ResNet image classification neural network (e.g., e.g., ResNet-18, ResNet-34, ResNet-50, ResNet-101, ResNet-152).

In certain embodiments, as further depicted by FIG. 2, the machine-learning model 206A may be trained to generate a tile-level class label prediction 208A for the image tile extracted and downsampled to N× magnification utilizing the slide-level class label associated with the histopathology image 202. Similarly, in certain embodiments, the machine-learning model 206B may be trained to generate a tile-level class label prediction 208B for the image tile extracted and downsampled to M× magnification utilizing the slide-level class label associated with the histopathology image 202. The machine-learning model 206C may be trained to generate a tile-level class label prediction 208C for the image tile extracted and downsampled to Y× magnification utilizing the slide-level class label associated with the histopathology image 202. Lastly, the machine-learning model 206D may be trained to generate a tile-level class label prediction 208D for the image tile extracted and downsampled to Z× magnification utilizing the slide-level class label with the histopathology image 202.

In certain embodiments, one or more of the generated tile-level class label prediction 208A, the generated tile-level class label prediction 208B, the generated tile-level class label prediction 208C, and the generated tile-level class label prediction 208D may be then upsampled (e.g., by way of upsampling functions 210A, 210B, 210C, and 210D) to normalize or scale each of the tile-level class label predictions 208A, 208B, 208C, and 208D to the same resolution. For example, in one embodiment, each of the tile-level class label predictions 208A, 208B, 208C, and 208D may be normalized or scaled to the magnification or resolution of the region of pixels (e.g., one or more tiles of pixels) previously downsampled to the maximum magnification (e.g., high-magnification “Z×”).

In certain embodiments, the normalized tile-level class label predictions 208A, 208B, 208C, and 208D may be then averaged (e.g., by way averaging function 212) to generate one or more tile-level class label predictions 214 for the histopathology image 202. For example, as previously noted, the machine-learning models 206A, 206B, 206C, and 206D may include an ensemble of machine-learning models (e.g., ensemble of CNNs or other similar image classification neural networks trained in parallel or end-to-end), and thus the normalized tile-level class label predictions 208A, 208B, 208C, and 208D may be averaged, for example, to significantly improve the accuracy of the one or more tile-level class label predictions 214 as compared to that of any one of the tile-level class label predictions 208A, 208B, 208C, and 208D.

In this way, the presently disclosed embodiments may provide predicted tile-level class labels for low-level features (e.g., a class label or bounding geometry identifying a specific region of cancer cells, a region of immune cells, one or more biomarkers corresponding to a specific region, or other region of features of clinical interest) within the histopathology image 202 utilizing only the respective extracted and downsampled regions of pixels (e.g., one or more tiles of pixels) and the sparse slide-level class label preassigned to the histopathology image 202. Indeed, without the presently disclosed embodiments, such tile-level annotation tasks would otherwise require time-consuming, costly, and potentially erroneous human annotation. Additionally, by training the machine-learning models (e.g., an ensemble of machine-learning models) to predict tile-level class labels at different magnifications, once trained, the machine-learning models (e.g., an ensemble of machine-learning models) may be better suited for predicting tile-level class labels for features of histopathology images at different magnifications and/or resolutions (e.g., similar to the manner in which a histopathologist would analyze and classify features of histopathology images).

In certain embodiments, once computed, the one or more tile-level class label predictions 214 for the histopathology image 202 may be utilized in one or more downstream tasks. For example, in some embodiments, a report may be generated based on the one or more tile-level class label predictions 214 for the histopathology image 202. For example, in one embodiment, the report may include a clinical report that may be associated with one or more cancer patients to be provided and displayed, for example, to a histopathologist or a clinician (e.g., oncologist) for purposes of research and/or the diagnosis, prognosis, and treatment of the one or more patients. In another embodiment, the report may include an interpretability and/or explainability report that may be associated with the machine-learning models 206A, 206B, 206C, and 206D to be provided and displayed, for example, to one or more data scientists or developers for purposes of ascertaining and elucidating the prediction and decision-making behaviors of the machine-learning models 206A, 206B, 206C, and 206D.

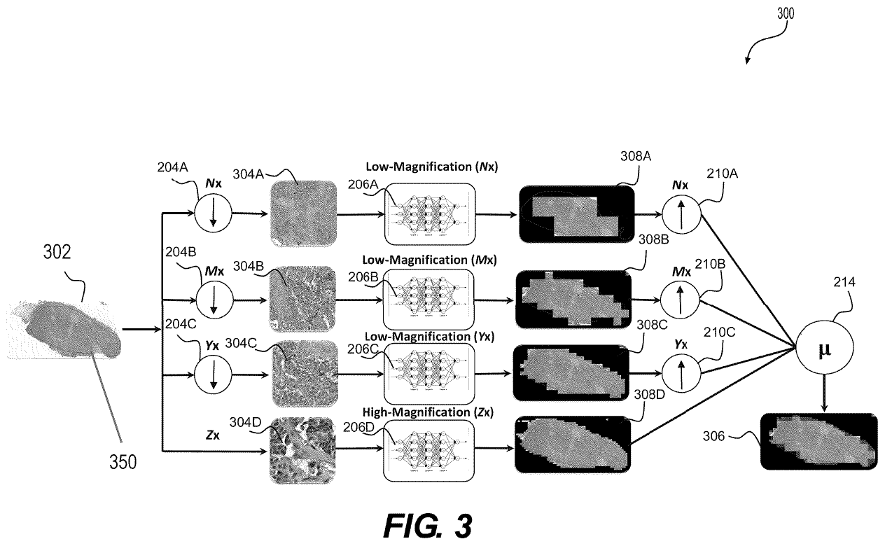

FIG. 3 illustrates an illustrative workflow diagram 300 for training one or more machine-learning models to generate a prediction of one or more tile-level class labels for a histopathology image based on a slide-level class label preassigned to the histopathology image, in accordance with the presently disclosed embodiments. Specifically, the illustrative workflow diagram 300 may generally correspond to the system workflow diagram 200 discussed above with respect to FIG. 2, illustrating the presently disclosed techniques as applied to, for example, an H&E histopathology image 302 including a slide-level annotation (e.g., as illustrated by the bounding geometry 350).

As depicted, in certain embodiments, the H&E histopathology image 302 may be accessed. As further illustrated by FIG. 3, in some embodiments, the H&E histopathology image 302 may be assigned a slide-level class label. For example, as previously noted, the histopathology image 202 may include a very large and high-resolution image depicting, for example, a large number of tissues or cells. In one embodiment, a histopathologist or other expert human annotator may have assigned a slide-level annotation to the H&E histopathology image 302, for example, by drawing a bounding geometry (e.g., as illustrated by the bounding geometry 350) around the tissues or cells depicted by the H&E histopathology image 302.

In certain embodiments, as further depicted by FIG. 3, a number of regions of pixels 304A, 304B, 304C, and 304D (e.g., one or more tiles of pixels) of the H&E histopathology image 302 may be extracted and downsampled (e.g., by way of respective downsampling functions 202A, 202B, and 202C) to a number of magnifications (e.g., low-magnification “N×,” low-magnification “M×,” low-magnification “Y×,” and up to high-magnification “Z×,” where “N”; “M”; “Y” and “Z” each includes an integer greater than 1). In one embodiment, a first image tile may be extracted and downsampled to 2× magnification, a second image tile may be extracted and downsampled to 5× magnification, a third image tile may be extracted and downsampled to 10× magnification, and a fourth image tile may be extracted and downsampled to 20× magnification.

In certain embodiments, as further depicted by FIG. 3, the number of regions of pixels 304A, 304B, 304C, and 304D (e.g., one or more tiles of pixels) may be then inputted into respective machine-learning models 206A, 206B, 206C, and 206D. In certain embodiments, as further depicted by FIG. 3, the machine-learning model 206A may be trained to generate a tile-level class label prediction 308A for the region of pixels 304A (e.g., image tile) utilizing the slide-level class label associated with the H&E histopathology image 302. Similarly, in certain embodiments, the machine-learning model 206B may be trained to generate a tile-level class label prediction 308B for the region of pixels 304B (e.g., image tile) utilizing the slide-level class label associated with the H&E histopathology image 302. The machine-learning model 206C may be trained to generate a tile-level class label prediction 308C for the region of pixels 304C (e.g., image tile) utilizing the slide-level class label associated with the H&E histopathology image 302. Lastly, the machine-learning model 206D may be trained to generate a tile-level class label prediction 308D for the region of pixels 304D (e.g., image tile) utilizing the slide-level class label associated with the H&E histopathology image 302.

In certain embodiments, one or more of the generated tile-level class label prediction 308A, the generated tile-level class label prediction 308B, the generated tile-level class label prediction 308C, and the generated tile-level class label prediction 308D may be then upsampled (e.g., by way of upsampling functions 210A, 210B, 210C, and 210D) to normalize or scale each of the tile-level class label predictions 308A, 308B, 308C, and 308D to the same resolution. For example, in one embodiment, each of the tile-level class label predictions 308A, 308B, 308C, and 308D may be normalized or scaled to the magnification or resolution of the region of pixels (e.g., one or more tiles of pixels) previously downsampled to the maximum magnification (e.g., high-magnification “Z×”). In certain embodiments, the normalized tile-level class label predictions 308A, 308B, 308C, and 308D may be then averaged (e.g., by way averaging function 212) to generate one or more tile-level class label predictions 306 for the H&E histopathology image 302.

For example, as previously noted, the machine-learning models 206A, 206B, 206C, and 206D may include an ensemble of machine-learning models (e.g., ensemble of CNNs or other image classification neural networks trained in parallel or end-to-end), and thus the normalized tile-level class label predictions 308A, 308B, 308C, and 308D may be averaged, for example, to significantly improve the accuracy of the one or more tile-level class label predictions 306 as compared to that of any one of the tile-level class label predictions 308A, 308B, 308C, and 308D.

In this way, the presently disclosed embodiments may provide predicted tile-level class labels for low-level features (e.g., a class label or bounding geometry identifying a specific region of cancer cells, a region of immune cells, one or more biomarkers corresponding to a specific region, or other region of features of clinical interest) within the H&E histopathology image 302 utilizing only the respective extracted and downsampled regions of pixels (e.g., one or more tiles of pixels) and the sparse slide-level class label preassigned to the H&E histopathology image 302. Indeed, without the presently disclosed embodiments, such tile-level annotation tasks would otherwise require time-consuming, costly, and potentially erroneous human annotation. Additionally, by training the machine-learning models (e.g., an ensemble of machine-learning models) to predict tile-level class labels at different magnifications, once trained, the machine-learning models (e.g., an ensemble of machine-learning models) may be better suited for predicting tile-level class labels for features of histopathology images at different magnifications and/or resolutions (e.g., similar to the manner in which a histopathologist would analyze and classify features of histopathology images).

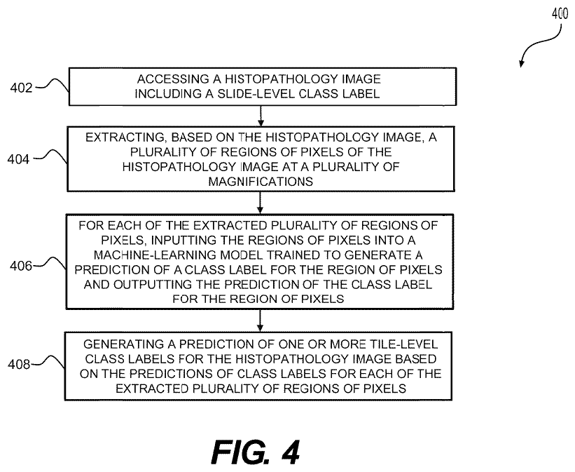

FIG. 4 illustrates a flow diagram of a method 400 for training one or more machine-learning models to generate a prediction of one or more tile-level class labels for a histopathology image based on a slide-level class label preassigned to the histopathology image, in accordance with the presently disclosed embodiments. The method 400 may be performed utilizing one or more processing devices (e.g., one or more of the network 100 of interacting computer systems as discussed above with respect to FIG. 1) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), neuromorphic processing unit (NPU), a wafer-scale engine (WSE), or any of various hardware AI accelerators) that may be suitable for processing various omics data and making one or more decisions based thereon, software (e.g., instructions running/executing on one or more processing devices), firmware (e.g., microcode), or some combination thereof.

The method may include at block 402 one or more processing devices accessing a histopathology image, in which the histopathology image includes a slide-level class label. For example, in one embodiment, the one or more processing devices may access a histopathology image 202 including a slide-level class label (e.g., a high-level or sparse image label such as “carcinoma tumor” or a hand-drawn bounding geometry covering too large of an area of disparate tissues, cells, or other features) preassigned to the histopathology image 202, for example, by a histopathologist or another expert human annotator. The method 400 may include at block 404 the one or more processing devices extracting, based on the histopathology image, a plurality of regions of pixels of the histopathology image at a plurality of magnifications. For example, in some embodiments, a number of regions of pixels (e.g., one or more tiles of pixels) of the histopathology image 202 may be extracted and downsampled to a number of magnifications (e.g., low-magnification “N×,” low-magnification “M×,” low-magnification “Y×,” and up to high-magnification “Z×,” where “N”; “M”; “Y” and “Z” each includes an integer greater than 1).

The method 400 may include at block 406 the one or more processing devices, for each of the extracted plurality of regions of pixels, inputting the region of pixels into a machine-learning model trained to generate a prediction of a tile-level class label for the region of pixels based on the region of pixels and the slide-level class label, and outputting, by the machine-learning model, the prediction of the class label for the region of pixels. For example, in certain embodiments, as discussed above with respect to FIG. 2, the number of regions of pixels (e.g., one or more tiles of pixels) may be then inputted into respective machine-learning models 206A, 206B, 206C, and 206D trained to generate respective tile-level class label predictions 208A, 208B, 208C, and 208D for each of the number of regions of pixels (e.g., one or more tiles of pixels) utilizing the number of respective regions of pixels (e.g., one or more tiles of pixels) and the slide-level class label preassigned to the histopathology image 202. The method 400 may include at block 408 one or more processing devices generating a prediction of one or more tile-level class labels for the histopathology image based on the predictions of class labels for each of the extracted plurality of regions of pixels. For example, in certain embodiments, the tile-level class label predictions 208A, 208B, 208C, and 208D may be averaged to generate one or more tile-level class label predictions 214 for the histopathology image 202.

In this way, the presently disclosed embodiments may provide predicted tile-level class labels for low-level features (e.g., a class label or bounding geometry identifying a specific region of cancer cells, a region of immune cells, one or more biomarkers corresponding to a specific region, or other region of features of clinical interest) within a histopathology image utilizing only the respective extracted and downsampled regions of pixels (e.g., one or more tiles of pixels) and a sparse slide-level class label preassigned to the histopathology image. Indeed, without the presently disclosed embodiments, such tile-level annotation tasks would otherwise require time-consuming, costly, and potentially erroneous human annotation. Additionally, by training the machine-learning models (e.g., an ensemble of machine-learning models) to predict tile-level class labels at different magnifications, once trained, the machine-learning models (e.g., an ensemble of machine-learning models) may be better suited for predicting tile-level class labels for features of histopathology images at different magnifications and/or resolutions (e.g., similar to the manner in which a histopathologist would analyze and classify features of histopathology images).

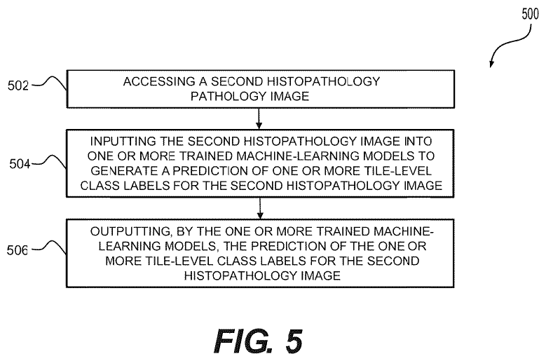

FIG. 5 illustrates a flow diagram of a method 500 for utilizing one or more machine-learning models to generate a prediction of one or more tile-level class labels for a histopathology image based on a slide-level class label preassigned to the histopathology image, in accordance with the presently disclosed embodiments. The method 500 may be performed utilizing one or more processing devices (e.g., one or more of the network 100 of interacting computer systems as discussed above with respect to FIG. 1) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), neuromorphic processing unit (NPU), a wafer-scale engine (WSE), or any of various hardware AI accelerators) that may be suitable for processing various omics data and making one or more decisions based thereon, software (e.g., instructions running/executing on one or more processing devices), firmware (e.g., microcode), or some combination thereof.

The method may include at block 502 one or more processing devices accessing a histopathology image. For example, in one embodiment, the one or more processing devices may access an unannotated histopathology image. The method 400 may include at block 404 the one or more processing devices inputting the histopathology image into one or more machine-learning models trained to generate a prediction of one or more tile-level class labels for the histopathology image. For example, in one embodiment, the one or more processing devices may input the unannotated histopathology image into an ensemble of machine-learning models (e.g., ensemble of CNNs or other similar image classification neural networks) trained to generate one or more tile-level class label predictions (e.g., a class label or bounding geometry identifying a specific region of cancer cells, a region of immune cells, one or more biomarkers corresponding to a specific region, or other region of features of clinical interest) for the histopathology image.

The method 500 may include at block 506 the one or more processing devices outputting, by the one or more machine-learning models, the prediction of the one or more tile-level class labels for the histopathology image. For example, as previously noted, the one or more machine-learning models (e.g., ensemble of CNNs or other similar image classification neural networks) may generate one or more tile-level class label predictions (e.g., a class label or bounding geometry identifying a specific region of cancer cells, a region of immune cells, one or more biomarkers corresponding to a specific region, or other region of features of clinical interest) for the histopathology image.

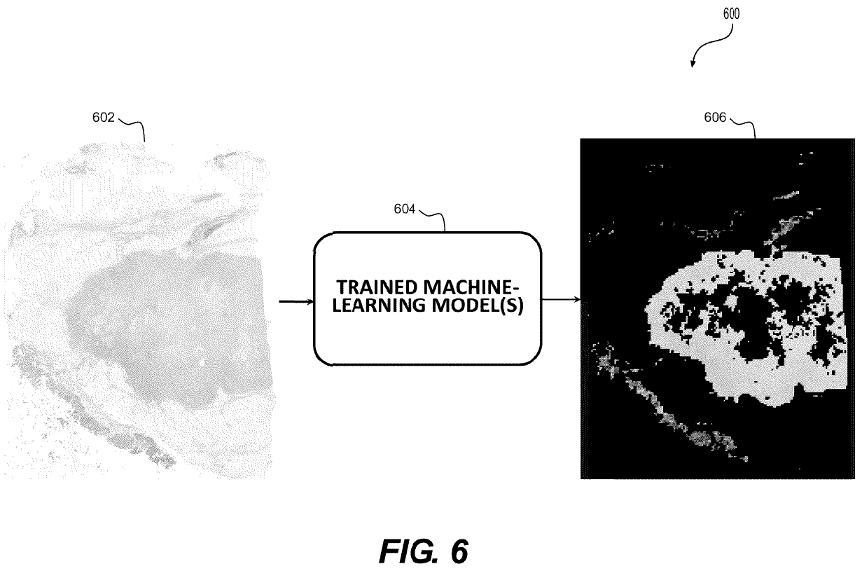

FIG. 6 illustrates a running example 600 of utilizing one or more machine-learning models to generate a prediction of one or more tile-level class labels for a histopathology image based on a slide-level class label preassigned to the histopathology image, in accordance with the presently disclosed embodiments. Specifically, in one embodiment, the running example 600 may be an illustrative embodiment of the method 500 as discussed above with respect to FIG. 5. As depicted, in certain embodiments, an unannotated histopathology image 602 may be accessed. In certain embodiments, the unannotated histopathology image 602 may be then inputted into one or more trained machine-learning models 604 (e.g., ensemble of CNNs or other similar image classification neural networks) trained to generate a prediction of one or more tile-level class labels for the unannotated histopathology image 602 in accordance with the presently disclosed embodiments.

For example, in one embodiment, the unannotated histopathology image 602 may be inputted into an ensemble of trained machine-learning models (e.g., ensemble of CNNs or other similar image classification neural networks) to generate and output one or more tile-level class label predictions (e.g., a class label or bounding geometry identifying a specific region of cancer cells, a region of immune cells, one or more biomarkers corresponding to a specific region, or other region of features of clinical interest) for the unannotated histopathology image 602. A histopathology image 606 illustrates the predicted class labels (e.g., a pixel-wise class labels identifying a tumor) that may be outputted by the one or more trained machine-learning models 604.

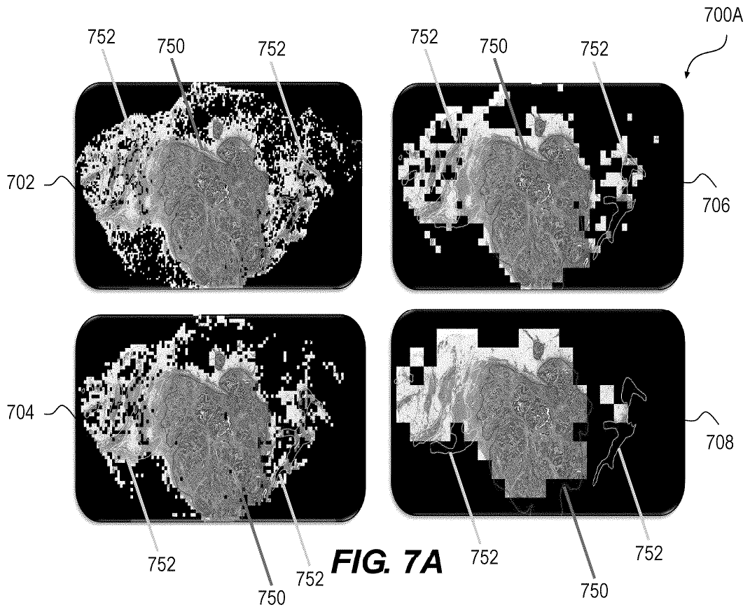

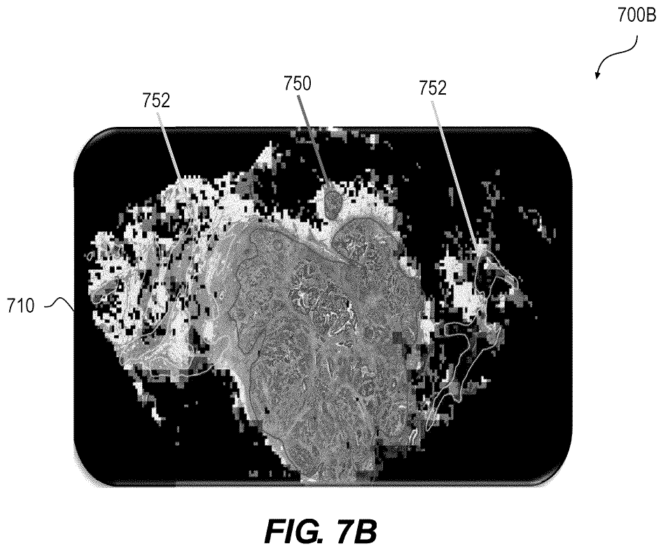

FIGS. 7A and 7B illustrate one or more graphical or implementation example of predictions of tile-level class labels for a histopathology image at different magnifications, in accordance with the presently disclosed embodiments. For example, in one embodiment, an annotated histopathology image 702 may include 2× magnification, an annotated histopathology image 704 may include 5× magnification, an annotated histopathology image 706 may include 10× magnification, and an annotated histopathology image 708 may include 20× magnification. As depicted in FIG. 7A, each of the annotated histopathology images 702, 704, 706, and 708 may include predicted tile-level class labels (e.g., illustrated by the first bounding geometry 750 and the second bounding geometry 752) in accordance with the presently disclosed embodiments. As depicted in FIG. 7B, an annotated histopathology image 710 illustrates the final prediction of one or more tile-level class labels (e.g., illustrated by the first bounding geometry 750 and the second bounding geometry 752) generated based on an averaging of the predicted tile-level class labels corresponding to the annotated histopathology images 702, 704, 706, and 708.

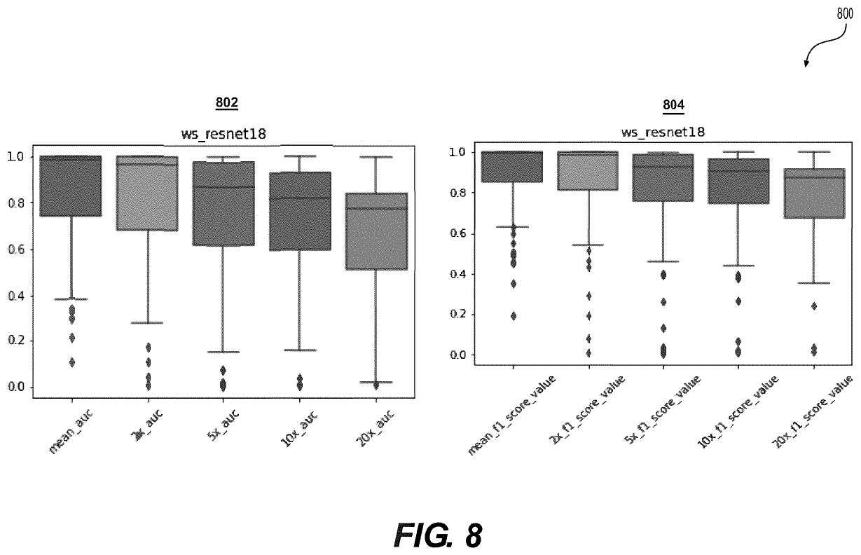

FIG. 8 illustrates an example machine-learning model evaluation diagram 800 (e.g., area under curve (AUC) (802) and F1 scores (804)), in accordance with the presently disclosed embodiments. As illustrated, the machine-learning model evaluation diagram 800 (e.g., ROC/AUC 802 and 804) may include indications of the respective prediction accuracies of the predicted tile-level class labels corresponding to the annotated histopathology images 702 (e.g., for 2× magnification, AUC value of approximately 0.90 and an F1 score of approximately 0.99), 704 (e.g., for 5× magnification, AUC value of approximately 0.85 and an F1 score of approximately 0.92), 706 (e.g., for 10× magnification, AUC value of approximately 0.82 and an F1 score of approximately 0.90), and 708 (e.g., for 20× magnification, AUC value of approximately 0.78 and an F1 score of approximately 0.87), for example, as compared to the prediction accuracy of the final prediction of one or more tile-level class labels (e.g., for averaged predictions, AUC value of approximately 0.99 and an F1 score of approximately 1.00) generated based on an averaging of the predicted tile-level class labels corresponding to the annotated histopathology images 702, 704, 706, and 708. Thus, in accordance with the presently disclosed techniques, the prediction accuracy of the final prediction of one or more tile-level class labels may be significantly improved as compared to that of any one of the predicted tile-level class labels corresponding to the annotated histopathology images 702, 704, 706, and 708.

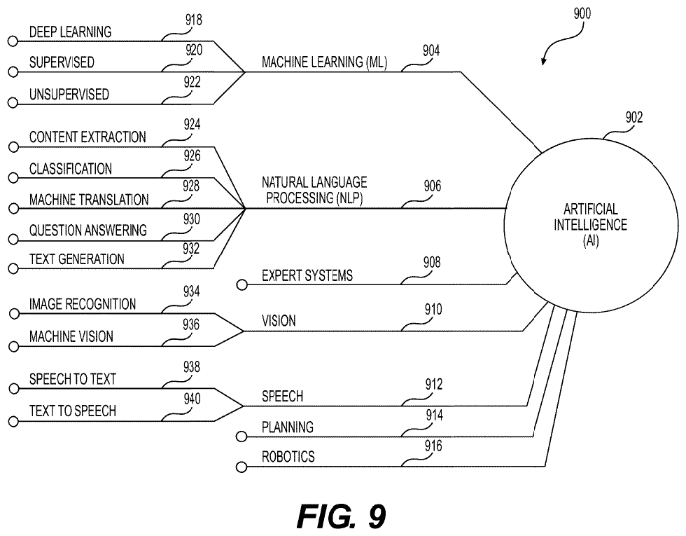

FIG. 9 illustrates a diagram 900 of an example artificial intelligence (AI) architecture 902 (which may be included as part of one or more of the network 100 of interacting computer systems as discussed above with respect to FIG. 1) that may be utilized for training one or more machine-learning models to generate a prediction of one or more tile-level class labels for a histopathology image based on a slide-level class label preassigned to the histopathology image, in accordance with the presently disclosed embodiments. In certain embodiments, the AI architecture 902 may be implemented utilizing, for example, one or more processing devices that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), neuromorphic processing unit (NPU), a wafer-scale engine (WSE), or any of various hardware artificial intelligence (AI) accelerators) that may be suitable for processing various omics data and making one or more decisions based thereon), software (e.g., instructions running/executing on one or more processing devices), firmware (e.g., microcode), or some combination thereof.

In certain embodiments, as depicted by FIG. 9, the AI architecture 902 may include machine learning (ML) models 904, natural language processing (NLP) models 906, expert systems 908, computer-based vision models 910, speech recognition models 912, planning models 914, and robotics models 916. In certain embodiments, the ML models 904 may include any statistics-based algorithms that may be suitable for finding patterns across large amounts of data (e.g., “Big Data” such as genomics data, proteomics data, metabolomics data, metagenomics data, transcriptomics data, and/or other omics data). For example, in certain embodiments, the ML models 904 may include deep learning algorithms 918, supervised learning algorithms 920, and unsupervised learning algorithms 922.

In certain embodiments, the deep learning algorithms 918 may include any artificial neural networks (ANNs) that may be utilized to learn deep levels of representations and abstractions from large amounts of data. For example, the deep learning algorithms 918 may include ANNs, such as a perceptron, a multilayer perceptron (MLP), an autoencoder (AE), a convolution neural network (CNN), a recurrent neural network (RNN), long short term memory (LSTM), a grated recurrent unit (GRU), a restricted Boltzmann Machine (RBM), a deep belief network (DBN), a bidirectional recurrent deep neural network (BRDNN), a generative adversarial network (GAN), and deep Q-networks, a neural autoregressive distribution estimation (NADE), an adversarial network (AN), attentional models (AM), a spiking neural network (SNN), deep reinforcement learning, and so forth.

In certain embodiments, the supervised learning algorithms 920 may include any algorithms that may be utilized to apply, for example, what has been learned in the past to new data using labeled examples for predicting future events. For example, starting from the analysis of a known training data set, the supervised learning algorithms 920 may produce an inferred function to make predictions about the output values. The supervised learning algorithms 620 may also compare its output with the correct and intended output and find errors in order to modify the supervised learning algorithms 920 accordingly. On the other hand, the unsupervised learning algorithms 922 may include any algorithms that may be applied, for example, when the data used to train the unsupervised learning algorithms 922 are neither classified nor labeled. For example, the unsupervised learning algorithms 922 may study and analyze how systems may infer a function to describe a hidden structure from unlabeled data.

In certain embodiments, the NLP models 906 may include any algorithms or functions that may be suitable for automatically manipulating natural language, such as speech and/or text. For example, in some embodiments, the NLP models 906 may include content extraction models 924, classification models 926, machine translation models 928, question answering (QA) models 930, and text generation models 932. In certain embodiments, the content extraction models 924 may include a means for extracting text or images from electronic documents (e.g., webpages, text editor documents, and so forth) to be utilized, for example, in other applications.

In certain embodiments, the classification models 926 may include any algorithms that may utilize a supervised learning model (e.g., logistic regression, naïve Bayes, stochastic gradient descent (SGD), k-nearest neighbors, decision trees, random forests, support vector machine (SVM), and so forth) to learn from the data input to the supervised learning model and to make new observations or classifications based thereon. The machine translation models 928 may include any algorithms or functions that may be suitable for automatically converting source text in one language, for example, into text in another language. The QA models 930 may include any algorithms or functions that may be suitable for automatically answering questions posed by humans in, for example, a natural language, such as that performed by voice-controlled personal assistant devices. The text generation models 932 may include any algorithms or functions that may be suitable for automatically generating natural language texts.

In certain embodiments, the expert systems 908 may include any algorithms or functions that may be suitable for simulating the judgment and behavior of a human or an organization that has expert knowledge and experience in a particular field (e.g., stock trading, medicine, sports statistics, and so forth). The computer-based vision models 910 may include any algorithms or functions that may be suitable for automatically extracting information from images (e.g., photo images, video images). For example, the computer-based vision models 910 may include image recognition algorithms 934 and machine vision algorithms 936. The image recognition algorithms 934 may include any algorithms that may be suitable for automatically identifying and/or classifying objects, places, people, and so forth that may be included in, for example, one or more image frames or other displayed data. The machine vision algorithms 936 may include any algorithms that may be suitable for allowing computers to “see,” or, for example, to rely on image sensors cameras with specialized optics to acquire images for processing, analyzing, and/or measuring various data characteristics for decision making purposes.

In certain embodiments, the speech recognition models 912 may include any algorithms or functions that may be suitable for recognizing and translating spoken language into text, such as through automatic speech recognition (ASR), computer speech recognition, speech-to-text (STT) 938, or text-to-speech (TTS) 940 in order for the computing to communicate via speech with one or more users, for example. In certain embodiments, the planning models 914 may include any algorithms or functions that may be suitable for generating a sequence of actions, in which each action may include its own set of preconditions to be satisfied before performing the action. Examples of AI planning may include classical planning, reduction to other problems, temporal planning, probabilistic planning, preference-based planning, conditional planning, and so forth. Lastly, the robotics models 916 may include any algorithms, functions, or systems that may enable one or more devices to replicate human behavior through, for example, motions, gestures, performance tasks, decision-making, emotions, and so forth.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to this disclosure are in particular disclosed in the attached claims directed to a method, a storage medium, a system and a computer program product, wherein any feature mentioned in one claim category, e.g., method, may be claimed in another claim category, e.g., system, as well. The dependencies or references back in the attached claims are chosen for formal reasons only. However, any subject matter resulting from a deliberate reference back to any previous claims (in particular multiple dependencies) may be claimed as well, so that any combination of claims and the features thereof are disclosed and may be claimed regardless of the dependencies chosen in the attached claims. The subject-matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim and/or in any combination with any embodiment or feature described or depicted herein or with any of the features of the attached claims.

### EXAMPLE EMBODIMENTS

Embodiments disclosed herein may include:
1. A method for training one or more machine-learning models to generate a prediction of one or more tile-level class labels for an image, the method comprising, by one or more computing devices: accessing a histopathology image, wherein the histopathology image comprises a slide-level class label; extracting, based on the histopathology image, a plurality of regions of pixels of the histopathology image at a plurality of magnifications; and for each of the extracted plurality of regions of pixels: inputting the region of pixels into a machine-learning model trained to generate a prediction of a class label for the region of pixels based on the region of pixels and the slide-level class label; and outputting, by the machine-learning model, the prediction of the class label for the region of pixels; and generating a prediction of one or more tile-level class labels for the histopathology image based on the predictions of class labels for each of the extracted plurality of regions of pixels.
2. The method of embodiment 1, wherein the prediction of the one or more tile-level class labels comprises an identification of one or more biomarkers associated with tissues or cells included within the histopathology image.
3. The method of embodiment 1 or embodiment 2, wherein extracting the plurality of regions of pixels of the histopathology image at the plurality of magnifications comprises downsampling the plurality of regions of pixels to the plurality of magnifications.
4. The method of any one of embodiments 1-3, further comprising: prior to generating the prediction of the one or more tile-level class labels, normalizing the predictions of class labels for each of the extracted plurality of regions of pixels.
5. The method of embodiment 4, wherein normalizing the predictions of class labels for each of the extracted plurality of regions of pixels comprises normalizing the predictions of class labels for each of the extracted plurality of regions of pixels to a scaling of the region of pixels at a maximum magnification.
6. The method of any one of embodiments 1-5, wherein generating the prediction of the one or more tile-level class labels comprises computing an average of the predictions of class labels for each of the extracted plurality of regions of pixels.
7. The method of any one of embodiments 1-6, further comprising: subsequent to training the one or more machine-learning models to generate a prediction of one or more tile-level class labels for the histopathology image: accessing a second histopathology image; inputting the second histopathology image into the trained one or more machine-learning models to generate a prediction of one or more tile-level class labels for the second histopathology image; and outputting, by the one or more machine-learning models, the prediction of the one or more tile-level class labels for the second histopathology image.
8. The method of embodiment 7, wherein the prediction of the one or more tile-level class labels for the second histopathology image comprises an identification of one or more biomarkers associated with tissues or cells included within the second histopathology image.
9. The method of any one of embodiments 1-8, wherein the machine-learning model comprises an artificial neural network (ANN), a convolutional neural network (CNN), or a deep neural network (DNN).
10. The method of any one of embodiments 1-9, wherein the machine-learning model comprises one of an ensemble of convolutional neural networks (CNNs).
11. The method of embodiment 10, wherein the ensemble of convolutional neural networks (CNNs) is configured to be trained concurrently.
12. The method of any one of embodiments 1-11, wherein training the one or more machine-learning models to generate the prediction of one or more tile-level class labels for the histopathology image comprises training the one or more machine-learning models in accordance with a weakly-supervised learning process.
13. The method of any one of embodiments 1-12, wherein each one of the plurality of magnifications is different from each other one of the plurality of magnifications.
14. The method of any one of embodiments 1-13, wherein the histopathology image comprises at least one of a histological stain image, a fluorescence in situ hybridization (FISH) image, an immunofluorescence (IF) image, or a hematoxylin and eosin (H&E) image.
15. The method of any one of embodiments 1-14, further comprising generating a report based on the prediction of the one or more tile-level class labels for the histopathology image.
16. The method of embodiment 15, further comprising causing a human machine interface (HMI) associated with a pathologist or a clinician to display the report.
17. A system including one or more computing devices for training one or more machine-learning models to generate a prediction of one or more tile-level class labels for an image, the one or more computing devices comprising: one or more non-transitory computer-readable storage media including instructions; and one or more processors coupled to the one or more storage media, the one or more processors configured to execute the instructions to: access a histopathology image, wherein the histopathology image comprises a slide-level class label; extract, based on the histopathology image, a plurality of regions of pixels of the histopathology image at a plurality of magnifications; and for each of the extracted plurality of regions of pixels: input the region of pixels into a machine-learning model trained to generate a prediction of a class label for the region of pixels based on the region of pixels and the slide-level class label; and output, by the machine-learning model, the prediction of the class label for the region of pixels; and generate a prediction of one or more tile-level class labels for the histopathology image based on the predictions of class labels for each of the extracted plurality of regions of pixels.
18. The system of embodiment 17, wherein the prediction of the one or more tile-level class labels comprises an identification of one or more biomarkers associated with tissues or cells included within the histopathology image.
19. The system of embodiment 17 or embodiment 18, wherein the instructions to extract the plurality of regions of pixels of the histopathology image at the plurality of magnifications further comprise instructions to downsample the plurality of regions of pixels to the plurality of magnifications.
20. The system of any one of embodiments 17-19, wherein the instructions further comprise instructions to: prior to generating the prediction of the one or more tile-level class labels, normalize the predictions of class labels for each of the extracted plurality of regions of pixels.
21. The system of embodiment 20, wherein the instructions to normalize the predictions of class labels for each of the extracted plurality of regions of pixels further comprise instructions to normalize the predictions of class labels for each of the extracted plurality of regions of pixels to a scaling of the region of pixels at a maximum magnification.
22. The system of any one of embodiments 17-21, wherein the instructions to generate the prediction of the one or more tile-level class labels further comprise instructions to compute an average of the predictions of class labels for each of the extracted plurality of regions of pixels.
23. The system of any one of embodiments 17-22, wherein the instructions further comprise instructions to: subsequent to training the one or more machine-learning models to generate a prediction of one or more tile-level class labels for a whole-slide histopathology image: access a second histopathology image; input the second histopathology image into the trained one or more machine-learning models to generate a prediction of one or more tile-level class labels for the second histopathology image; and output, by the one or more machine-learning models, the prediction of the one or more tile-level class labels for the second histopathology image.
24. The system of embodiment 23, wherein the prediction of the one or more tile-level class labels for the second histopathology image comprises an identification of one or more biomarkers associated with tissues or cells included within the second histopathology image.
25. The system of any one of embodiments 17-24, wherein the machine-learning model comprises an artificial neural network (ANN), a convolutional neural network (CNN), or a deep neural network (DNN).
26. The system of any one of embodiments 17-25, wherein the machine-learning model comprises one of an ensemble of convolutional neural networks (CNNs).
27. The system of embodiment 26, wherein the ensemble of convolutional neural networks (CNNs) is configured to be trained concurrently.
28. The system of any one of embodiments 17-27, wherein the instructions to train the one or more machine-learning models to generate the prediction of one or more tile-level class labels for the histopathology image further comprise instructions to train the one or more machine-learning models in accordance with a weakly-supervised learning process.
29. The system of any one of embodiments 17-28, wherein each one of the plurality of magnifications is different from each other one of the plurality of magnifications.
30. The system of any one of embodiments 17-29, wherein the histopathology image comprises at least one of a histological stain image, a fluorescence in situ hybridization (FISH) image, an immunofluorescence (IF) image, or a hematoxylin and eosin (H&E) image.
31. The system of any one of embodiments 17-30, wherein the instructions further comprise instructions to generate a report based on the prediction of the one or more tile-level class labels for the histopathology image.
32. The system of embodiment 31, wherein the instructions further comprise instructions to cause a human machine interface (HMI) associated with a pathologist or a clinician to display the report.
33. A non-transitory computer-readable medium comprising instructions that, when executed by one or more processors of one or more computing devices, cause the one or more processors to: access a histopathology image, wherein the histopathology image comprises a slide-level class label; extract, based on the histopathology image, a plurality of regions of pixels of the histopathology image at a plurality of magnifications; and for each of the extracted plurality of regions of pixels: input the region of pixels into a machine-learning model trained to generate a prediction of a class label for the region of pixels based on the region of pixels and the slide-level class label; and output, by the machine-learning model, the prediction of the class label for the region of pixels; and generate a prediction of one or more tile-level class labels for the histopathology image based on the predictions of class labels for each of the extracted plurality of regions of pixels.
34. The non-transitory computer-readable medium of embodiment 33, wherein the prediction of the one or more tile-level class labels comprises an identification of one or more biomarkers associated with tissues or cells included within the histopathology image.
35. The non-transitory computer-readable medium of embodiment 33 or embodiment 34, wherein the instructions to extract the plurality of regions of pixels of the histopathology image at the plurality of magnifications further comprise instructions to downsample the plurality of regions of pixels to the plurality of magnifications.
36. The non-transitory computer-readable medium of any one of embodiments 33-35, wherein the instructions further comprise instructions to: prior to generating the prediction of the one or more tile-level class labels, normalize the predictions of class labels for each of the extracted plurality of regions of pixels.
37. The non-transitory computer-readable medium of embodiment 36, wherein the instructions to normalize the predictions of class labels for each of the extracted plurality of regions of pixels further comprise instructions to normalize the predictions of class labels for each of the extracted plurality of regions of pixels to a scaling of the region of pixels at a maximum magnification.
38. The non-transitory computer-readable medium of any one of embodiments 33-37, wherein the instructions to generate the prediction of the one or more tile-level class labels further comprise instructions to compute an average of the predictions of class labels for each of the extracted plurality of regions of pixels.
39. The non-transitory computer-readable medium of any one of embodiments 33-38, wherein the instructions further comprise instructions to: subsequent to training the one or more machine-learning models to generate a prediction of one or more tile-level class labels for a whole-slide histopathology image: access a second histopathology image; input the second histopathology image into the trained one or more machine-learning models to generate a prediction of one or more tile-level class labels for the second histopathology image; and output, by the one or more machine-learning models, the prediction of the one or more tile-level class labels for the second histopathology image.
40. The non-transitory computer-readable medium of embodiment 39, wherein the prediction of the one or more tile-level class labels for the second histopathology image comprises an identification of one or more biomarkers associated with tissues or cells included within the second histopathology image.
41. The non-transitory computer-readable medium of any one of embodiments 33-40, wherein the machine-learning model comprises an artificial neural network (ANN), a convolutional neural network (CNN), or a deep neural network (DNN).
42. The non-transitory computer-readable medium of any one of embodiments 33-41, wherein the machine-learning model comprises one of an ensemble of convolutional neural networks (CNNs).
43. The non-transitory computer-readable medium of embodiment 42, wherein the ensemble of convolutional neural networks (CNNs) is configured to be trained concurrently.
44. The non-transitory computer-readable medium of any one of embodiments 33-43, wherein the instructions to train the one or more machine-learning models to generate the prediction of one or more tile-level class labels for the histopathology image further comprise instructions to train the one or more machine-learning models in accordance with a weakly-supervised learning process.
45. The non-transitory computer-readable medium of any one of embodiments 33-44, wherein each one of the plurality of magnifications is different from each other one of the plurality of magnifications.
46. The non-transitory computer-readable medium of any one of embodiments 33-45, wherein the histopathology image comprises at least one of a histological stain image, a fluorescence in situ hybridization (FISH) image, an immunofluorescence (IF) image, or a hematoxylin and eosin (H&E) image.
47. The non-transitory computer-readable medium of any one of embodiments 33-46, wherein the instructions further comprise instructions to generate a report based on the prediction of the one or more tile-level class labels for the histopathology image.
48. The non-transitory computer-readable medium of embodiment 47, wherein the instructions further comprise instructions to cause a human machine interface (HMI) associated with a pathologist or a clinician to display the report.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

What is claimed is:

1. A method for training one or more machine-learning models to generate a prediction of one or more tile-level class labels for an image, the method comprising, by one or more computing devices:
accessing a histopathology image, wherein the histopathology image comprises a slide-level class label;
extracting, based on the histopathology image, a plurality of regions of pixels of the histopathology image at a plurality of magnifications; and
for each of the extracted plurality of regions of pixels:
inputting the region of pixels into a machine-learning model trained to generate a prediction of a class label for the region of pixels based on the region of pixels and the slide-level class label; and
outputting, by the machine-learning model, the prediction of the class label for the region of pixels; and
generating a prediction of one or more tile-level class labels for the histopathology image based on the predictions of class labels for each of the extracted plurality of regions of pixels.

2. The method of claim 1, wherein the prediction of the one or more tile-level class labels comprises an identification of one or more biomarkers associated with tissues or cells included within the histopathology image.

3. The method of claim 1, wherein extracting the plurality of regions of pixels of the histopathology image at the plurality of magnifications comprises downsampling the plurality of regions of pixels to the plurality of magnifications.

4. The method of claim 1, further comprising:
prior to generating the prediction of the one or more tile-level class labels, normalizing the predictions of class labels for each of the extracted plurality of regions of pixels.

5. The method of claim 4, wherein normalizing the predictions of class labels for each of the extracted plurality of regions of pixels comprises normalizing the predictions of class labels for each of the extracted plurality of regions of pixels to a scaling of the region of pixels at a maximum magnification.

6. The method of claim 1, wherein generating the prediction of the one or more tile-level class labels comprises computing an average of the predictions of class labels for each of the extracted plurality of regions of pixels.

7. The method of claim 1, further comprising:
subsequent to training the one or more machine-learning models to generate a prediction of one or more tile-level class labels for the histopathology image:
accessing a second histopathology image;
inputting the second histopathology image into the trained one or more machine-learning models to generate a prediction of one or more tile-level class labels for the second histopathology image; and
outputting, by the one or more machine-learning models, the prediction of the one or more tile-level class labels for the second histopathology image.

8. The method of claim 7, wherein the prediction of the one or more tile-level class labels for the second histopathology image comprises an identification of one or more biomarkers associated with tissues or cells included within the second histopathology image.

9. The method of claim 1, wherein the machine-learning model comprises an artificial neural network (ANN), a convolutional neural network (CNN), or a deep neural network (DNN).

10. The method of claim 1, wherein the machine-learning model comprises one of an ensemble of convolutional neural networks (CNNs).

11. The method of claim 10, wherein the ensemble of convolutional neural networks (CNNs) is configured to be trained concurrently.

12. The method of claim 1, wherein training the one or more machine-learning models to generate the prediction of one or more tile-level class labels for the histopathology image comprises training the one or more machine-learning models in accordance with a weakly-supervised learning process.

13. The method of claim 1, wherein each one of the plurality of magnifications is different from each other one of the plurality of magnifications.

14. The method of claim 1, wherein the histopathology image comprises at least one of a histological stain image, a fluorescence in situ hybridization (FISH) image, an immunofluorescence (IF) image, or a hematoxylin and eosin (H&E) image.

15. The method of claim 1, further comprising generating a report based on the prediction of the one or more tile-level class labels for the histopathology image.

16. The method of claim 15, further comprising causing a human machine interface (HMI) associated with a pathologist or a clinician to display the report.

17. A system including one or more computing devices for training one or more machine-learning models to generate a prediction of one or more tile-level class labels for an image, the one or more computing devices comprising:
one or more non-transitory computer-readable storage media including instructions; and
one or more processors coupled to the one or more storage media, the one or more processors configured to execute the instructions to:
access a histopathology image, wherein the histopathology image comprises a slide-level class label;
extract, based on the histopathology image, a plurality of regions of pixels of the histopathology image at a plurality of magnifications; and
for each of the extracted plurality of regions of pixels:
input the region of pixels into a machine-learning model trained to generate a prediction of a class label for the region of pixels based on the region of pixels and the slide-level class label; and
output, by the machine-learning model, the prediction of the class label for the region of pixels; and
generate a prediction of one or more tile-level class labels for the histopathology image based on the predictions of class labels for each of the extracted plurality of regions of pixels.

18. The system of claim 17, wherein the prediction of the one or more tile-level class labels comprises an identification of one or more biomarkers associated with tissues or cells included within the histopathology image.

19. The system of claim 17, wherein the instructions to extract the plurality of regions of pixels of the histopathology image at the plurality of magnifications further comprise instructions to downsample the plurality of regions of pixels to the plurality of magnifications.

20. A non-transitory computer-readable medium comprising instructions that, when executed by one or more processors of one or more computing devices, cause the one or more processors to:
access a histopathology image, wherein the histopathology image comprises a slide-level class label;
extract, based on the histopathology image, a plurality of regions of pixels of the histopathology image at a plurality of magnifications; and
for each of the extracted plurality of regions of pixels:
input the region of pixels into a machine-learning model trained to generate a prediction of a class label for the region of pixels based on the region of pixels and the slide-level class label; and
output, by the machine-learning model, the prediction of the class label for the region of pixels; and
generate a prediction of one or more tile-level class labels for the histopathology image based on the predictions of class labels for each of the extracted plurality of regions of pixels.
